(19) United States
(12) Patent Application Publication
(10) Pub. No.: US 2015/0171388 A1
(43) Pub. Date: Jun. 18, 2015

(54) BATTERY MODULE

(71) Applicant: SAMSUNG SDI CO., LTD., Yongin-si (KR)

(72) Inventors: Myung-Jae JANG, Yongin-si (KR); Sang-Won BYUN, Yongin-si (KR)

(21) Appl. No.: 14/548,510

(22) Filed: Nov. 20, 2014

(30) Foreign Application Priority Data
Dec. 16, 2013 (KR) 10-2013-0156617

(51) Int. Cl. H01M 2/10; H01M 10/0525; H01M 2/02

(52) U.S. Cl. CPC H01M 2/1077; H01M 2/024; H01M 10/0525; H01M 2220/20

(57) ABSTRACT

A battery module including a plurality of unit batteries that are disposed along a first direction, each of the unit batteries including a top surface having a terminal, a bottom surface opposite to the top surface, and first, second, third, and fourth side surfaces that are between the top surface and the bottom surface; a retainer; and a housing accommodating the unit batteries and the retainer, wherein the plurality of unit batteries includes a first unit battery, the first unit battery being at least partially surrounded by the retainer, and a second unit battery, the second unit battery being adjacent to the first unit battery and not being surrounded by the retainer.

### CROSS-REFERENCE TO RELATED APPLICATION

Korean Patent Application No. 10-2013-0156617, filed on Dec. 16, 2013, in the Korean Intellectual Property Office, and entitled: “Battery Module, ” is incorporated by reference herein in its entirety.

### BACKGROUND

1. Field

Embodiments relate to a battery module.

2. Description of the Related Art

When secondary batteries are used as power supply units for small electronic apparatuses such as mobile phones or notebook computers, the secondary batteries may be used in the form of a single battery. As secondary batteries are used in large vehicles such as hybrid cars, the secondary batteries may be used in the form of a battery module including a plurality of batteries, in line with the demand for high-power and high-capacity batteries.

### SUMMARY

Embodiments are directed to a battery module.

The embodiments may be realized by providing a battery module including a plurality of unit batteries that are disposed along a first direction, each of the unit batteries including a top surface having a terminal, a bottom surface opposite to the top surface, and first, second, third, and fourth side surfaces that are between the top surface and the bottom surface; a retainer; and a housing accommodating the unit batteries and the retainer, wherein the plurality of unit batteries includes a first unit battery, the first unit battery being at least partially surrounded by the retainer, and a second unit battery, the second unit battery being adjacent to the first unit battery and not being surrounded by the retainer.

The retainer may include a first barrier on the first side surface of the first unit battery, a second barrier on the second side surface of the first unit battery, the second side surface being opposite to the first side surface of the first unit battery, and a third barrier that connects the first barrier and the second barrier, the third barrier being on the third side surface of the first unit battery that is substantially perpendicular to the first side surface and the second side surface of the first unit battery.

The first barrier may be between the first side surface of the first unit battery and the second side surface of the second unit battery, the second side surface of the second unit battery facing the first side surface of the first unit battery, and the second barrier may be between the second side surface of the first unit battery and the first side surface of a third unit battery, the first side surface of the third unit battery facing the second side surface of the first unit battery.

The first barrier may directly contact the first side surface of the first unit battery and the second side surface of the second unit battery, and the second barrier may directly contact the second side surface of the first unit battery and the first side surface of the third unit battery.

The first barrier may convexly protrude toward the first side surface of the first unit battery and toward the second side surface of the second unit battery.

The second barrier may convexly protrude toward the second side surface of the first unit battery and toward the first side surface of the third unit battery.

The retainer may further include a fourth barrier that connects the first barrier and the second barrier, the fourth barrier being on the fourth side surface of the first unit battery that is substantially perpendicular to the first side surface and the second side surface of the first unit battery.

The retainer may include polyurethane.

The housing may include a first end plate and a second end plate that are disposed at an outermost portion of the housing with the plurality of unit batteries and the retainer interposed therebetween; and a connector that connects the first end plate and the second end plate such that the first end plate and the second end plate press against the unit batteries and the retainer that are interposed therebetween.

The embodiments may be realized by providing a battery module including a plurality of unit batteries that are disposed along a first direction such that side surfaces of unit batteries of the plurality of unit batteries face each other; a retainer that covers at least three surfaces of even-numbered position or odd-numbered position unit batteries of the unit batteries; and a housing accommodating the unit batteries and the retainer.

The retainer may protrude convexly toward the side surfaces of the unit batteries.

The unit batteries may include a first unit battery, at least three surfaces of the first unit battery being at least partially covered by the retainer; a second unit battery adjacent to the first unit battery; and third unit battery adjacent to the first unit battery and opposite to the second unit battery with the first unit battery disposed therebetween.

One side surface of the second unit battery may contact a first portion of the retainer, the first portion of the retainer covering the first unit battery, and one side surface of the third unit battery may contact a second portion of the retainer, the second portion of the retainer covering the first unit battery.

The retainer may include a first barrier that covers a first side surface of the first unit battery, the first barrier being interposed between the first side surface of the first unit battery and one side surface of the second unit battery that faces the first side surface of the first unit battery; a second barrier that covers a second side surface of the first unit battery, the second barrier being interposed between the second side surface of the first unit battery and one side surface of the third unit battery that faces the second side surface of the first unit battery; and a third barrier that connects the first barrier and the second barrier, the third barrier covering a third side surface of the first unit battery.

At least one of the first barrier and the second barrier may protrude convexly in the first direction.

The retainer may surround the side surfaces of the even-numbered position or odd-numbered position unit batteries.

The retainer may include polyurethane.

Each of the unit batteries may include a case that includes a metallic material, that has a hexahedral shape, and that has a top surface including an opening; an electrode assembly that is received in the case and that includes a first electrode plate, a second electrode plate, and a separator between the first electrode plate and the second electrode plate; a cap plate that seals the opening; and a terminal on the cap plate, the terminal protruding away from the cap plate.

### BRIEF DESCRIPTION OF THE DRAWINGS

Features will be apparent to those of skill in the art by describing in detail exemplary embodiments with reference to the attached drawings in which:

FIG. 1 illustrates a schematic perspective view of a battery module according to an embodiment;

FIG. 2 illustrates an exploded perspective view of FIG. 1;

FIG. 3 illustrates a cross-sectional view taken along a line of FIG. 2, which illustrates unit batteries of the battery module;

FIG. 4 illustrates a top view of the unit batteries and a retainer of FIG. 1;

FIG. 5 illustrates a perspective view of a retainer according to another embodiment;

FIG. 6 illustrates a schematic exploded perspective view of a battery module according to another embodiment; and

FIG. 7 illustrates a top view of the unit batteries and a retainer of FIG. 6.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

As used herein, expressions such as “at least one of,” when preceding a list of elements, modify the entire list of elements and do not modify the individual elements of the list.

It will be understood that although the terms “first”, “second”, etc. may be used herein to describe various components, these components should not be limited by these terms. These terms are only used to distinguish one component from another.

As used herein, the singular forms “a”, “an” and “the” are intended to include the plural forms as well, unless the context clearly indicates otherwise.

It will be further understood that the terms “comprise”, “include” and “have” used herein specify the presence of stated features or components, but do not preclude the presence or addition of one or more other features or components.

It will be understood that when a layer, region, or component is referred to as being “formed on” another layer, region, or component, it may be directly or indirectly formed on the other layer, region, or component. For example, intervening layers, regions, or components may be present.

Sizes of components in the drawings may be exaggerated for convenience of description. In other words, since sizes and thicknesses of components in the drawings are arbitrarily illustrated for convenience of description, the following embodiments are not limited thereto.

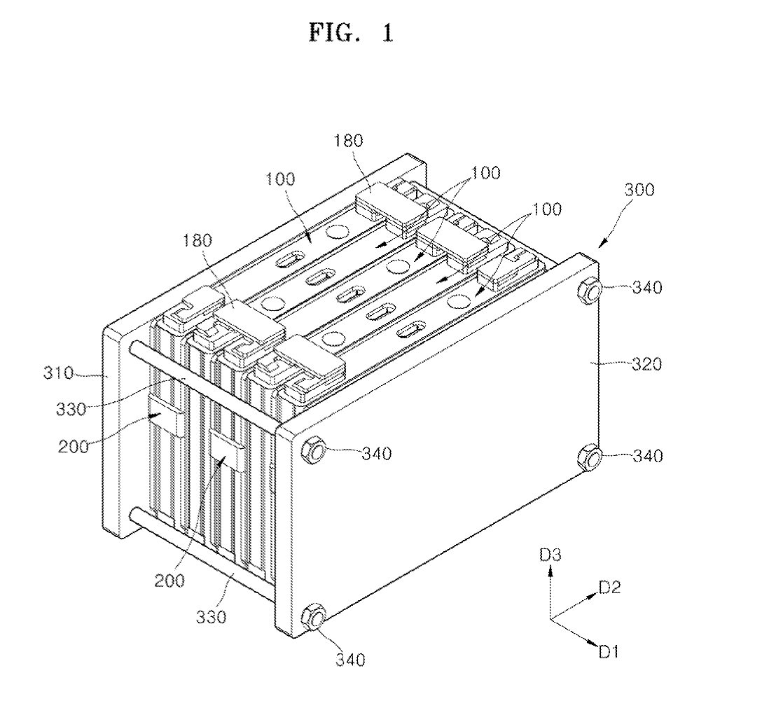

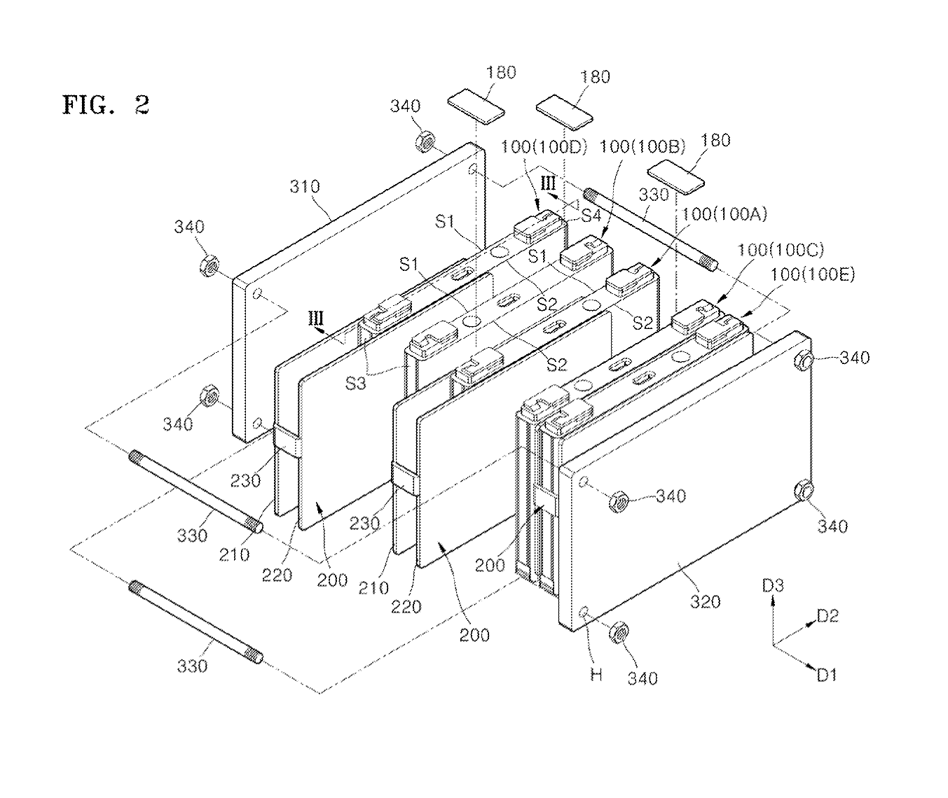

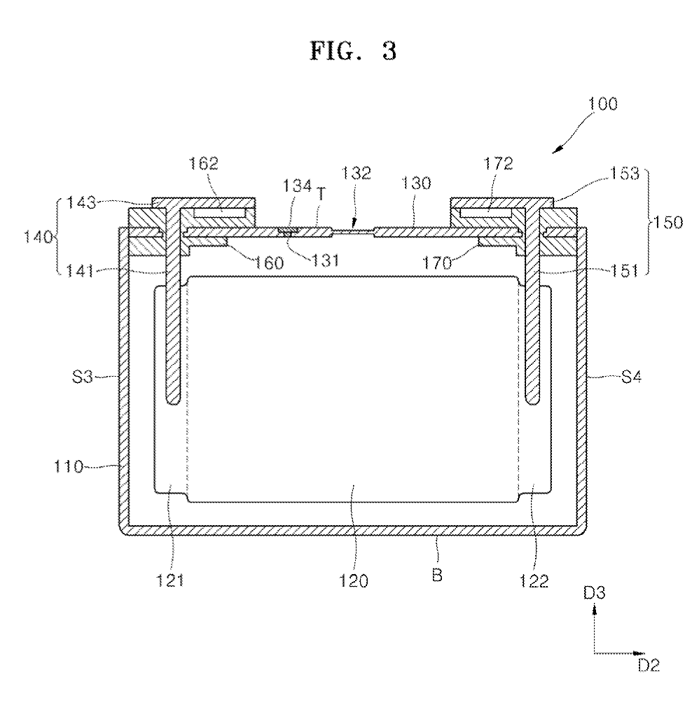

FIG. 1 illustrates a schematic perspective view of a battery module according to an embodiment. FIG. 2 illustrates an exploded perspective view of FIG. 1. FIG. 3 illustrates a cross-sectional view taken along a line of FIG. 2, which illustrates unit batteries 100 of the battery module.

Referring to FIGS. 1 and 2, the battery module according to an embodiment may include a plurality of unit batteries 100, a retainer 200, and a housing 300.

The unit batteries 100 may be disposed along a first direction. For example, the unit batteries 100 may be disposed along the first direction such that side surfaces, e.g., wide side surfaces, of adjacent unit batteries 100 face each other. For example, a first side surface S1 of any one of the adjacent unit batteries 100 may face a second side surface S2 of another of the adjacent unit batteries 100.

Referring to FIGS. 2 and 3, each of the unit batteries 100 may be, e.g., an approximately hexahedral lithium-ion battery. For example, each of the unit batteries 100 may include: a top surface T where a terminal is formed; a bottom surface B that is opposite to the top surface T; and first, second, third, and fourth side surfaces S1, S2, S3, and S4 that are between the top surface T and the bottom surface B. The first side surface S1 and the second side surface S2 may be opposite to each other; the third side surface S3 and the fourth side surface S4 may be opposite to each other; and the first and second side surfaces S1 and S2 may be substantially perpendicular to the third and fourth side surfaces S3 and S4. The unit batteries 100 may be disposed along the first direction such that the first side surface S1 and the second side surface S2 face each other.

Referring to FIG. 3, each of the unit batteries 110 may include: a case 110 that includes an opening; an electrode assembly 120 that is received in the case 110; a cap plate 130 that seals the opening of the case 110; and terminals 140 and 150 that protrude away from the cap plate 130.

The case 110 may include the opening for receiving the electrode assembly 120. The case 110 may have an approximately hexahedral shape on which the opening is formed, and may be formed of a metallic material in order to have rigidity. For example, the case 110 may be formed of aluminum or an aluminum alloy.

The electrode assembly 120 may be received in the case 110 through the opening. The electrode assembly 120 may include a first electrode plate; a second electrode plate; and a separator that is interposed between the first electrode plate and the second electrode plate. The first electrode plate (e.g., negative electrode plate) may include: a coated portion (in which a copper foil is coated with a negative electrode active material); and an uncoated portion 121 (that is not coated with a negative electrode active material). The second electrode plate (e.g., positive electrode plate) may include: a coated portion (in which an aluminum foil is coated with a positive electrode active material); and an uncoated portion 122 (that is not coated with a positive electrode active material).

The electrode assembly 120 may be formed by stacking the first electrode plate, the separator, and the second electrode plate sequentially and winding the resulting structure in a jelly-roll shape. In this case, the electrode assembly 120 may be formed such that the uncoated portion 121 of the first electrode plate and the uncoated portion 122 of the second electrode plate are exposed in opposite directions, for example, a D2 direction and a −D2 direction illustrated in FIG. 3. The uncoated portion 121 of the first electrode plate (exposed in the −D2 direction) may have a first polarity (e.g., negative electrode) of the electrode assembly 120, and the uncoated portion 122 of the second electrode plate (exposed in the D2 direction) may have a second polarity (e.g., positive electrode) of the electrode assembly 120.

As noted above, in an implementation, the electrode assembly 120 may be formed by stacking the first electrode plate, the separator, and the second electrode plate and winding the resulting structure. In an implementation, the electrode assembly 120 may be a stack-type electrode assembly that is formed by stacking the first electrode plate, the separator, and the second electrode plate sequentially.

The cap plate 130 may be joined to the opening of the case 110. Like the case 110, the cap plate 130 may be formed of a metallic material such as aluminum or an aluminum alloy. The cap plate 130 may include an electrolyte inlet 131 for electrolyte injection. The electrode assembly 120 may be received in the case 110, the opening may be sealed by the cap plate 130, and then an electrolyte may be injected into the case 110 through the electrolyte inlet 131. After completion of the electrolyte injection, the electrolyte inlet 131 is sealed by a plug 134.

The cap plate 130 may include a vent 132. The vent 132 may break open to discharge a gas from the case 110 when an internal pressure of the case 110 is abnormally high, e.g., higher than a predetermined reference pressure.

The terminals 140 and 150 may protrude upwardly from the cap plate 130. The terminals 140 and 150 may include: a first terminal 140 (e.g., that functions as a negative electrode of the unit battery 100); and a second terminal 150 (e.g., that functions as a positive electrode of the unit battery 100).

As noted above, in an implementation, the first terminal 140 may be a negative electrode of the unit battery 100 and the second terminal 150 may be a positive electrode of the unit battery 100. In an implementation, the first terminal 140 may be a positive electrode of the unit battery 100 and the second terminal 150 may be a negative electrode of the unit battery 100.

The first terminal 140 may include a first current collector 141 and a first terminal plate 143. The first current collector 141 may be electrically connected to the uncoated portion 121 of the first electrode plate after passing through a first insulator 160. The first terminal plate 143 may be a region to which a bus bar 180 is joined, and may be disposed on the cap plate 130 and exposed to the outside thereof.

The first insulator 160 may electrically insulate the first terminal 140 and the cap plate 130. The first insulator 160 may include a groove at one region thereof, and a first gap 162 may be formed between the first insulator 160 and the first terminal plate 143 as the groove is formed.

The first gap 162 may be formed at a position that overlaps the bus bar 180 disposed on the first terminal plate 143. The first gap 162 may help prevent heat from being transferred to the cap plate 130 when the first terminal plate 143 and the bus bar 180 are welded together, and may help prevent heat from deforming the first insulator 160.

The second terminal 150 may include a second current collector 151 and a second terminal plate 153. The second current collector 151 may be electrically connected to the uncoated portion 122 of the second electrode plate after passing through a second insulator 170. The second terminal plate 153 may be a region to which a bus bar 180 is joined, and may be disposed on the cap plate 130 and exposed to the outside thereof.

The second insulator 170 may electrically insulate the second terminal 150 and the cap plate 130. The second insulator 170 may include a groove at one region thereof, and a second gap 172 may be formed between the second insulator 170 and the second terminal plate 153 as the groove is formed.

The second gap 172 may be formed at a position that overlaps the bus bar 180 disposed on the second terminal plate 153. The second gap 172 may help prevent heat from being transferred to the cap plate 130 when the second terminal plate 153 and the bus bar 180 are welded together, and may help prevent heat from deforming the second insulator 170.

Referring to FIGS. 1 and 2, the unit batteries 100 having the above structure may be connected to each other by the bus bar 180. For example, the unit batteries 100 may be connected in series as the bus bar 180 is welded to the first and second terminals 140 and 150 of the adjacent unit batteries 100. In an implementation, the unit batteries 100 may be connected in parallel or in series-parallel.

The retainer 200 may at least partially surround some of the unit batteries 100. For example, the retainer 200 may at least partially surround the unit batteries 100 that are disposed on alternate orders, among the unit batteries 100 that are disposed along the first direction, e.g., may at least partially surround alternating unit batteries 100 that alternate in the first direction.

In an implementation, the retainer 200 may at least partially surround odd-numbered position unit batteries, e.g., 100D, 100A, and 100E, among the unit batteries 100 that are disposed along the first direction, and may not surround even-numbered position unit batteries, e.g., 100B and 100C.

In this manner, the retainer 200 may at least partially surround the unit batteries 100D, 100A, and 100E that are disposed on alternate orders, among the unit batteries 100 that are disposed along the first direction, e.g., may at least partially surround alternating unit batteries 100D, 100A, and 100E that alternate in the first direction. Therefore, one (e.g., 100A) of the adjacent unit batteries (e.g., 100A and 100B) may be surrounded by the retainer 200, while the other of the adjacent unit batteries (e.g. 100B) may not be surrounded by the retainer 200.

In an implementation, the retainer 200 may at least partially surround the odd-numbered position unit batteries, e.g., 100D, 100A, and 100E, and may not surround the even-numbered position unit batteries, e.g., 100B and 100C.

In an implementation, the retainer 200 may at least partially surround even-numbered position unit batteries, e.g., 100B and 100C, among the unit batteries 100 that are disposed along the first direction, and may not surround odd-numbered position unit batteries, e.g., 100D, 100A, and 100E.

In this manner, the retainer 200 may at least partially surround the unit batteries 100B and 100C that are disposed on alternate orders, among the unit batteries 100 that are disposed along the first direction, e.g., may at least partially surround alternating unit batteries 100B and 100C that alternate in the first direction. Therefore, one (e.g., 100B) of the adjacent unit batteries (e.g., 100A and 100B) may be surrounded by the retainer 200, while the other of the adjacent unit batteries (e.g. 100A) may not be surrounded by the retainer 200.

Hereinafter, for convenience of description, it is assumed that the retainer 200 at least partially surrounds the odd-numbered position unit batteries 100D, 100A, and 100E and does not surround the even-numbered position unit batteries 100B and 100C.

The retainer 200 may cover, e.g., at least partially cover, three surfaces of the unit battery 100. For example, the retainer 200 may include: a first barrier 210; a second barrier 220 (that is substantially parallel to the first barrier 210); and a third barrier 230 that connects the first and second barriers 210 and 220 and that may be integrated with the first and second barriers 210 and 220 (e.g., the retainer 200 may have a monolithic, one-piece structure). When the battery module is assembled, the first barrier 210 may be on the first side surface Si of the unit battery 100; the second barrier 220 may be on the second side surface S2 of the unit battery 100; and the third barrier 230 may be on the third side surface S3 of the unit battery 100. The first barrier 210 may cover, e.g., completely cover, the first side surface S1 of the unit battery 100; the second barrier 220 may cover, e.g., completely cover, the second side surface S2 of the unit battery 100; and the third barrier 230 may at least partially cover the third side surface S3 of the unit battery 100.

The retainer 200 may cover the three side surfaces S1, S2, and S3 of the odd-numbered position unit batteries 100A, 100D, and 100E, and the unit batteries 100 disposed along the first direction may be received in the housing 300 with the first barrier 210 or the second barrier 220 of the retainer 200 interposed therebetween.

The retainer 200 may include, e.g., polyurethane. Polyurethane has excellent absorptiveness with respect to vibration and a high repulsive force by compression. Thus, the battery module may have excellent dimensional stability if when each of the unit battery 100 swells during repeated charge and discharge.

The housing 300 may receive the unit batteries 100 and the retainer 200. The housing 300 may include, e.g., first and second end plates 310 and 320 (at an outermost portion of the housing 300 on the unit batteries 100); and a connection member or connector, e.g., a bolt 330 and a nut 340, that connect the first and second end plates 310 and 320.

The first and second end plates 310 and 320 may be substantially parallel to the first and second barriers 210 and 220 of the retainer 200. The first and second end plates 310 and 320 may inwardly press the unit batteries 100 that are interposed therebetween.

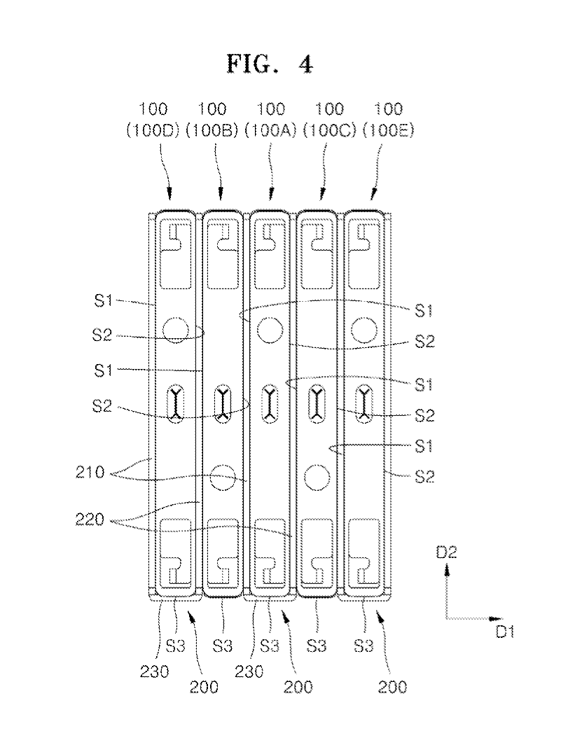

Hereinafter, the disposition and structure of the retainer 200 and the unit batteries 100 will be described in detail with reference to FIG. 4.

FIG. 4 illustrates a top view of the unit batteries 100 and the retainer 200 of FIG. 1.

Referring to FIG. 4, the retainer 200 may cover the first, second, and third side surfaces S1, S2, and S3 of the odd-numbered position unit batteries, e.g., 100D, 100A, and 100E; and the even-numbered position unit batteries, e.g., 100B and 100C, (that are not surrounded by the retainer 200) may be interposed between the odd-numbered position unit batteries, e.g., 100D, 100A, and 100E, that are at least partially surrounded by the retainer 200.

Hereinafter, for convenience of description, one of the odd-numbered position unit batteries, e.g., 100D, 100A, and 100E, is referred to as a first unit battery 100A, and the unit batteries 100 at sides of the first unit battery 100A are respectively referred to as a second unit battery 100B and a third unit battery 100C.

The retainer 200 may include: the first barrier 210 on the first side surface S1 of the first unit battery 100A; the second barrier 220 on the second side surface S2 of the first unit battery 100A; and the third barrier 230 on the third side surface S3 of the first unit battery 100A. The first barrier 210 may cover, e.g., completely cover, the first side surface S1 of the first unit battery 100A; the second barrier 220 may cover, e.g., completely cover, the second side surface S2 of the first unit battery 100A; and the third barrier 230 may at least partially cover the third side surface S3 of the first unit battery 100A.

The first unit battery 100A may be at least partially surrounded, e.g., on three sides, by the retainer 200, and the first barrier 210 may be interposed between the first and second unit batteries 100A and 100B and the second barrier 220 may be interposed between the first and third unit batteries 100A and 100C. For example, the first barrier 210 may be interposed between the first side surface Si of the first unit battery 100A and the second side surface S2 of the second unit battery 100B, and the second barrier 220 may be interposed between the second side surface S2 of the first unit battery 100A and the first side surface S1 of the third unit battery 100C.

The retainer 200 and the unit batteries 100 (between the first and second end plates 310 and 320) may be inwardly pressed by the joining of the first and second end plates 310 and 320, the first barrier 210 may contact the first and second unit batteries 100A and 100B, and the second barrier 220 may contact the first and third unit batteries 100A and 100C. For example, the first barrier 210 may directly contact the first side surface Si of the first unit battery 100A and the second side surface S2 of the second unit battery 100B, and the second barrier 220 may directly contact the second side surface S2 of the first unit battery 100A and the first side surface Si of the third unit battery 100C.

In an implementation, the first barrier 210 or the second barrier 220 may be interposed between the unit batteries 100 through a relatively simple process of inserting the approximately U-shaped retainer 200 into or onto some of the unit batteries 100, e.g., the odd-numbered position unit batteries 100D, 100A, and 100E.

By comparison, if a planar-type retainer were to be inserted between the unit batteries 100, the unit batteries 100 and the planar-type retainer may have to be aligned, and ease of assembly and dimensional stability of the battery module may be degraded.

According to an embodiment, the retainer 200 may surround at least three surfaces of the, e.g., odd-numbered position unit batteries 100, and may be inserted into or onto at least one of the adjacent unit batteries 100, the ease of assembly and the dimensional stability of the battery module may be improved.

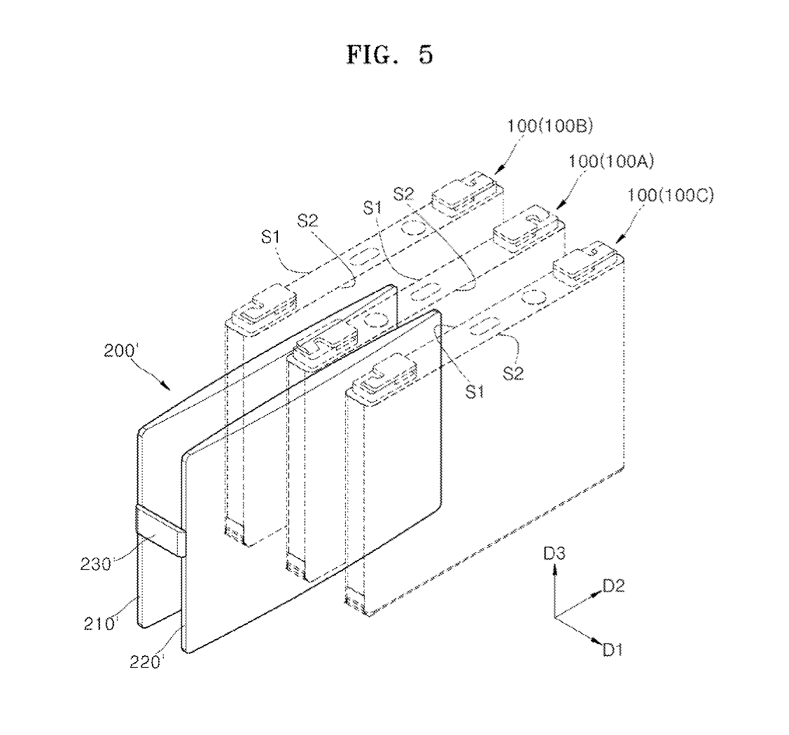

FIG. 5 illustrates a perspective view of a retainer 200′ according to another embodiment.

Referring to FIG. 5, at least one of a first barrier 210′ and a second barrier 220′ of the retainer 200′ may be convexed toward the side surfaces S1 and S2 of the unit battery 100, e.g., may convexly protrude toward the side surfaces S1 and S2 of the unit battery 100. For example, the first barrier 210′ may be convexed toward the first side surface S1 of the first unit battery 100A and the second side surface S2 of the second unit battery 100B and/or the second barrier 220′ may be convexed toward the second side surface S2 of the first unit battery 100A and the first side surface S1 of the third unit battery 100C.

When the unit battery 100 has a hexahedral shape (as illustrated in FIG. 5), swelling thereof may occur remarkably or mostly along the D1 direction. For example, the swelling may occur greatly or mostly at a center region of the first and second side surfaces S1 and S2. The swelling of the unit battery 100 may occur repeatedly over a long period of time. The repulsive or elastic force (with respect to compression) of the first and second barriers 210′ and 220′ receiving a compressive force by the repeated swelling could degrade with time. According to an embodiment, the first and second barriers 210′ and 220′ may convexly protrude toward the side surfaces S1 and S2 of the unit battery 100, and the retainer 200′ may help prevent the repulsive force of the first and second barriers 210′ and 220′ from being degraded.

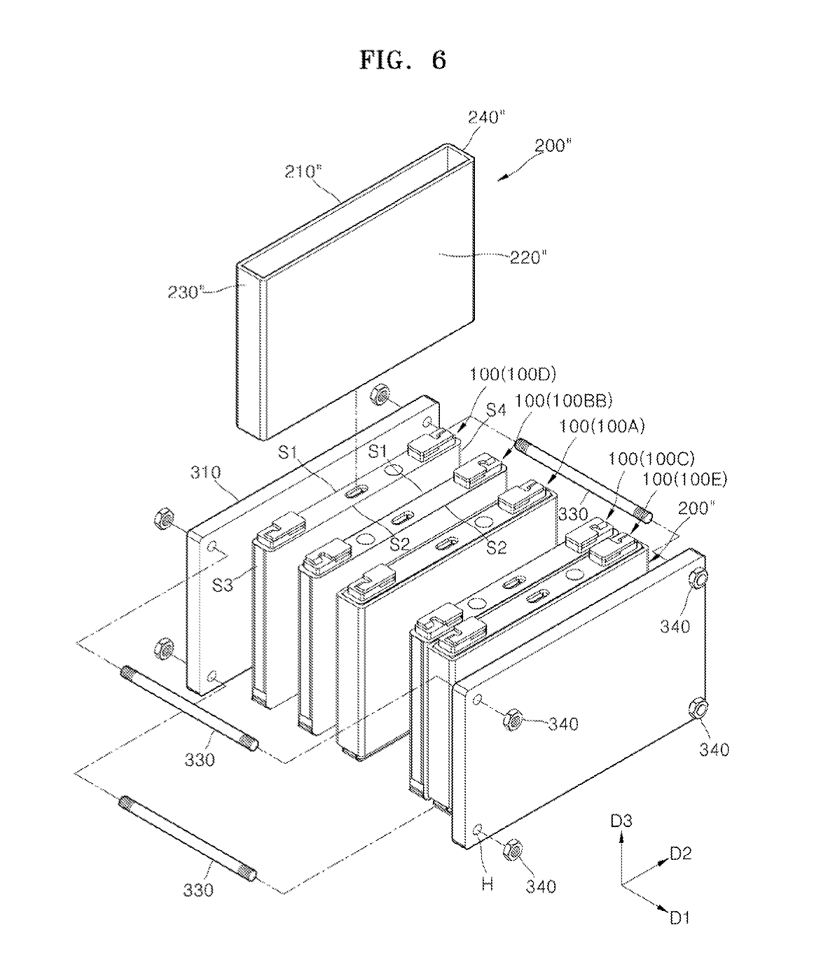

FIG. 6 illustrates a schematic exploded perspective view of a battery module according to another embodiment.

Referring to FIG. 6, the battery module according to the present embodiment may include a plurality of unit batteries 100, a retainer 200″, and a housing (like the battery module described with reference to FIGS. 1 to 5). Since the configurations of the unit batteries 100 and the housing according to the present embodiment are similar to the configurations of the unit batteries 100 and the housing 300 described with reference to FIGS. 1 and 2, differences therebetween will be mainly described below.

The retainer 200″ may at least partially surround, e.g., three sides of, the odd-numbered position unit batteries, e.g., 100D, 100A, and 100E, among the unit batteries 100. Thus, the even-numbered position unit batteries, e.g., 100B and 100C, may be between the odd-numbered position unit batteries, e.g., 100D, 100A, and 100E, without being surrounded by the retainer 200″.

The retainer 200″ may cover four surfaces of the unit battery 100. For example, the retainer 200″ may include: a first barrier 210″; a second barrier 220″ that is substantially parallel to the first barrier 210″; a third barrier 230″ that connects the first and second barriers 210″ and 220″ and that is integrated with the first and second barriers 210″ and 220″; and a fourth barrier 240″ that connects the first and second barriers 210″ and 220″ and is parallel to the third barrier 230″. For example, the retainer 200″ may have a monolithic, one-piece structure.

When the battery module is assembled, the first barrier 210″ may be on the first side surface S1 of the unit battery 100; the second barrier 220″ may be on the second side surface S2 of the unit battery 100; the third barrier 230″ may be on the third side surface S3 of the unit battery 100; and the fourth barrier 240″ may be on the fourth side surface S4 of the unit battery 100. The first barrier 210″ may cover, e.g., completely cover, the first side surface Si of the unit battery 100; the second barrier 220″ may cover, e.g., completely cover, the second side surface S2 of the unit battery 100; the third barrier 230″ may cover, e.g., completely cover, the third side surface S3 of the unit battery 100; and the fourth barrier 240″ may cover, e.g., completely cover, the fourth side surface S4 of the unit battery 100.

The retainer 200″ may cover the four side surfaces S1, S2, S3, and S4 of the odd-numbered position unit batteries, e.g., 100D, 100A, and 100E, and the unit batteries 100 disposed or arranged along the first direction may be received in the housing 300 with the first barrier 210″ or the second barrier 220″ of the retainer 200″ interposed therebetween.

The retainer 200″ may include polyurethane and may have excellent absorptiveness with respect to vibration and a high repulsive or elastic force by compression.

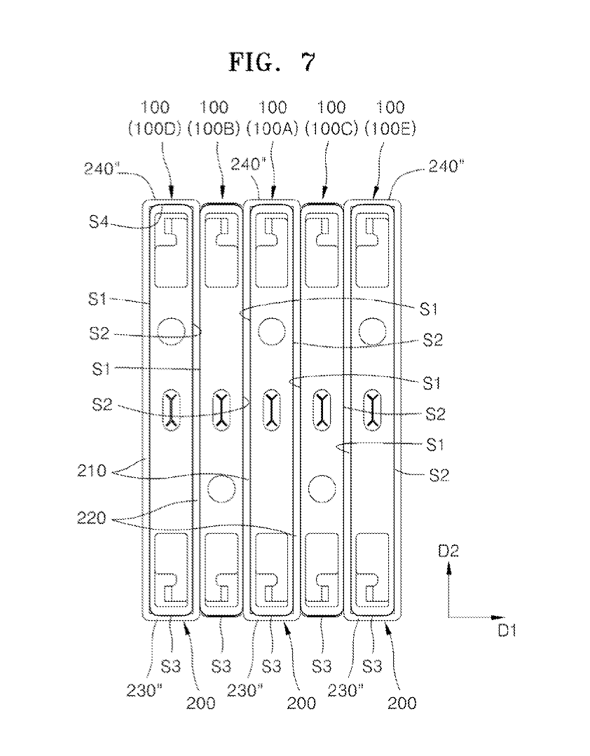

Hereinafter, the disposition and structure of the retainer 200″ and the unit batteries 100 will be described in detail with reference to FIG. 7.

FIG. 7 illustrates a top view of the unit batteries 100 and the retainer 200″ of FIG. 6.

Referring to FIG. 7, the retainer 200″ may cover, e.g., completely cover, the first, second, third, and fourth side surfaces S1, S2, S3, and S4 of the odd-numbered position unit batteries, e.g., 100D, 100A, and 100E; and the even-numbered position unit batteries, e.g., 100B and 100C, that are not surrounded by the retainer 200″ may be interposed between the odd-numbered position unit batteries 100D, 100A, and 100E that are at least partially surrounded by the retainer 200″.

Hereinafter, for convenience of description, one of the odd-numbered position unit batteries, e.g., 100D, 100A, and 100E, is referred to as a first unit battery 100A, and the unit batteries at sides of the first unit battery 100A are respectively referred to as a second unit battery 100B and a third unit battery 100C.

The retainer 200″ may include: the first barrier 210″ on the first side surface S1 of the first unit battery 100A; the second barrier 220″ on the second side surface S2 of the first unit battery 100A; the third barrier 230″ on the third side surface S3 of the first unit battery 100A; and the fourth barrier 240″ on the fourth side surface S4 of the first unit battery 100A. The first barrier 210″ may cover, e.g., completely cover, the first side surface Si of the first unit battery 100A; the second barrier 220″ may cover, e.g., completely cover, the second side surface S2 of the first unit battery 100A; the third barrier 230″ may cover, e.g., completely cover, the third side surface S3 of the first unit battery 100A; and the fourth barrier 240″ may cover, e.g., completely cover, the fourth side surface S4 of the first unit battery 100A.

The first unit battery 100A may be surrounded by the retainer 200″, and the first barrier 210″ may be between the first and second unit batteries 100A and 100B and the second barrier 220″ may be interposed between the first and third unit batteries 100A and 100C. For example, the first barrier 210″ may be between the first side surface S1 of the first unit battery 100A and the second side surface S2 of the second unit battery 100B, and the second barrier 220″ may be between the second side surface S2 of the first unit battery 100A and the first side surface S1 of the third unit battery 100C.

The retainer 200″ and the unit batteries 100 between the first and second end plates 310 and 320 may be inwardly pressed by the joining of the first and second end plates 310 and 320, and the first barrier 210″ may contact the first and second unit batteries 100A and 100B and the second barrier 220″ may contact the first and third unit batteries 100A and 100C. For example, the first barrier 210″ may directly contact the first side surface Si of the first unit battery 100A and the second side surface S2 of the second unit battery 100B, and the second barrier 220″ may directly contact the second side surface S2 of the first unit battery 100A and the first side surface Si of the third unit battery 100C.

According to the present embodiment, the first barrier 210″ or the second barrier 220″ may be interposed between the unit batteries 100 through a relatively simple process of inserting the approximately rectangular-shaped retainer 200″ into or onto the odd-numbered position unit batteries, e.g., 100D, 100A, and 100E, among the unit batteries 100. Thus, the ease of assembly of the battery module may be improved, any swelling of the battery module after the assembly of the battery module may be absorbed, and any misalignment of the retainer 200″ due to the swelling may be reduced and/or prevented. Therefore, the degradation of the dimensional stability of the battery module may be reduced and/or prevented.

By way of summation and review, when a battery module is used over a long period of time, a structure of the battery module may be deformed due to various factors, e.g., swelling and heating of batteries forming the battery module. Stable operation of the batteries may be frustrated due to the deformation of battery module structure. The embodiments may provide a battery module structure that does not deform even when the battery module is used over a long period of time.

As described above, according to the one or more of the above embodiments, it is possible to provide a battery module that absorbs the swelling of unit batteries and includes a retainer having excellent assembleability or ease of assembly.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery module, comprising:
a plurality of unit batteries that are disposed along a first direction, each of the unit batteries including:
a top surface having a terminal,
a bottom surface opposite to the top surface, and
first, second, third, and fourth side surfaces that are between the top surface and the bottom surface;
a retainer; and
a housing accommodating the unit batteries and the retainer,
wherein the plurality of unit batteries includes:
a first unit battery, the first unit battery being at least partially surrounded by the retainer, and
a second unit battery, the second unit battery being adjacent to the first unit battery and not being surrounded by the retainer.

2. The battery module as claimed in claim 1, wherein the retainer includes:
a first barrier on the first side surface of the first unit battery,
a second barrier on the second side surface of the first unit battery, the second side surface being opposite to the first side surface of the first unit battery, and
a third barrier that connects the first barrier and the second barrier, the third barrier being on the third side surface of the first unit battery that is substantially perpendicular to the first side surface and the second side surface of the first unit battery.

3. The battery module as claimed in claim 2, wherein:
the first barrier is between the first side surface of the first unit battery and the second side surface of the second unit battery, the second side surface of the second unit battery facing the first side surface of the first unit battery, and
the second barrier is between the second side surface of the first unit battery and the first side surface of a third unit battery, the first side surface of the third unit battery facing the second side surface of the first unit battery.

4. The battery module as claimed in claim 3, wherein:
the first barrier directly contacts the first side surface of the first unit battery and the second side surface of the second unit battery, and
the second barrier directly contacts the second side surface of the first unit battery and the first side surface of the third unit battery.

5. The battery module as claimed in claim 3, wherein the first barrier convexly protrudes toward the first side surface of the first unit battery and toward the second side surface of the second unit battery.

6. The battery module as claimed in claim 3, wherein the second barrier convexly protrudes toward the second side surface of the first unit battery and toward the first side surface of the third unit battery.

7. The battery module as claimed in claim 2, wherein the retainer further includes a fourth barrier that connects the first barrier and the second barrier, the fourth barrier being on the fourth side surface of the first unit battery that is substantially perpendicular to the first side surface and the second side surface of the first unit battery.

8. The battery module as claimed in claim 1, wherein the retainer includes polyurethane.

9. The battery module as claimed in claim 1, wherein the housing includes:
a first end plate and a second end plate that are disposed at an outermost portion of the housing with the plurality of unit batteries and the retainer interposed therebetween; and
a connector that connects the first end plate and the second end plate such that the first end plate and the second end plate press against the unit batteries and the retainer that are interposed therebetween.

10. A battery module, comprising:
a plurality of unit batteries that are disposed along a first direction such that side surfaces of unit batteries of the plurality of unit batteries face each other;
a retainer that covers at least three surfaces of even-numbered position or odd-numbered position unit batteries of the unit batteries; and
a housing accommodating the unit batteries and the retainer.

11. The battery module as claimed in claim 10, wherein the retainer protrudes convexly toward the side surfaces of the unit batteries.

12. The battery module as claimed in claim 10, wherein the unit batteries include:
a first unit battery, at least three surfaces of the first unit battery being at least partially covered by the retainer;
a second unit battery adjacent to the first unit battery; and
a third unit battery adjacent to the first unit battery and opposite to the second unit battery with the first unit battery disposed therebetween.

13. The battery module as claimed in claim 12, wherein:
one side surface of the second unit battery contacts a first portion of the retainer, the first portion of the retainer covering the first unit battery, and one side surface of the third unit battery contacts a second portion of the retainer, the second portion of the retainer covering the first unit battery.

14. The battery module as claimed in claim 12, wherein the retainer includes:
a first barrier that covers a first side surface of the first unit battery, the first barrier being interposed between the first side surface of the first unit battery and one side surface of the second unit battery that faces the first side surface of the first unit battery;
a second barrier that covers a second side surface of the first unit battery, the second barrier being interposed between the second side surface of the first unit battery and one side surface of the third unit battery that faces the second side surface of the first unit battery; and
a third barrier that connects the first barrier and the second barrier, the third barrier covering a third side surface of the first unit battery.

15. The battery module as claimed in claim 14, wherein at least one of the first barrier and the second barrier protrudes convexly in the first direction.

16. The battery module as claimed in claim 10, wherein the retainer surrounds the side surfaces of the even-numbered position or odd-numbered position unit batteries.

17. The battery module as claimed in claim 10, wherein the retainer includes polyurethane.

18. The battery module as claimed in claim 10, wherein each of the unit batteries includes:
a case that includes a metallic material, that has a hexahedral shape, and that has a top surface including an opening;
an electrode assembly that is received in the case and that includes a first electrode plate, a second electrode plate, and a separator between the first electrode plate and the second electrode plate;
a cap plate that seals the opening; and
a terminal on the cap plate, the terminal protruding away from the cap plate.
